(19) United States
(12) Patent Application Publication
(10) Pub. No.: US 2025/0193076 A1
(43) Pub. Date: Jun. 12, 2025

(54) SYSTEMS AND METHODS FOR ENHANCED TELECOMMUNICATIONS NETWORK ACTIVATION

(71) Applicant: Level 3 Communications, LLC, Denver, CO (US)

(72) Inventors: Syed HAIDER, South Elgin, IL (US); Christopher MAHAN, Kansas City, MO (US); Boris ABRAMOVICH, Maple Grove, MN (US); Brett DWYER, Clermont, FL (US); Michael L. NYHUS, Denver, CO (US); James C. DWYER, Spring, TX (US); Liong ONG, Golden, CO (US); Wen WANG, Ballwin, MO (US)

(73) Assignee: Level 3 Communications, LLC, Denver, CO (US)

(21) Appl. No.: 18/972,545

(22) Filed: Dec. 6, 2024

Related U.S. Application Data
(60) Provisional application No. 63/607,561, filed on Dec. 7, 2023.

(51) Int. Cl. H04L 41/0816; H04L 41/12

(52) U.S. Cl. CPC H04L 41/0816; H04L 41/12

(57) ABSTRACT

This disclosure describes systems, methods, and devices related to activating services and devices in a telecommunications network. A method may include receiving a user request for a service facilitated by a telecommunications network; identifying, based on the service, a device or port to which the user connects to access the telecommunications network; sending, based on the device or port, discovery commands to retrieve information from one or more additional devices in the telecommunications network; retrieving, based on the discovery commands, the information from the one or more additional devices; identifying, based on the information, a second device to which the device or port may connect to generate a path to an endpoint of the telecommunications network; generating, based on the device or port and the second device, a path from a location of the user to the endpoint; and provisioning the service for the user based on the path.

### CROSS-REFERENCE TO RELATED APPLICATION

This application claims the benefit of priority from U.S. Provisional Patent Application No. 63/607,561, filed Dec. 7, 2023, which is incorporated herein by reference in its entirety.

This application is related to U.S. patent application Ser. No. 17/564,461, filed Dec. 29, 2021, published as U.S. Pub. No. 2022/0209991, titled “SYSTEMS AND METHODS FOR AUTOMATED NETWORK CONFIGURATIONS WITH A NETWORK AS A SERVICE (NAAS) SYSTEM,” and U.S. patent application Ser. No. 17/966,852, filed Oct. 16, 2022, published as U.S. Pub. No. 2023/0044149, titled “NETWORK SERVICE ACTIVATION SYSTEM,” which are hereby incorporated in full by reference in their entirety herein.

### TECHNICAL FIELD

Embodiments of the present disclosure generally relate to systems and methods for activating services and devices in a telecommunications network.

### BACKGROUND

In some telecommunications network inventory systems, when a network is activated, an inventory of telecommunications network resources may provide information indicating which telecommunications network resources are used for which services and which customers, and which computer resources are available. An inventory-based order may rely on the information in the inventory of the telecommunications network to select telecommunications network resources to activate to provide a service to a customer. However, the information in the network inventory may not always be in sync with the actual status of resources in the telecommunications network.

### SUMMARY

According to some embodiments, a method for provisioning resources in a telecommunications network is disclosed, which according to some embodiments, can include: receiving a user request for a service facilitated by a telecommunications network, the user request identifying a location of a user; identifying, based on the service, a device or port to which the user connects to access the telecommunications network; sending, based on the device or port, discovery commands to retrieve information from one or more additional devices in the telecommunications network; retrieving, based on the discovery commands, the information from the one or more additional devices; identifying, based on the information, a second device to which the device or port may connect to generate a path to an endpoint of the telecommunications network; generating, based on the device or port and the second device, a path from the location of the user to the endpoint in the telecommunications network; and provisioning the service for the user based on the path without presenting a quote to the user indicating an amount of time expected to provision the service.

According to some embodiments, a system for provisioning resources in a telecommunications network is disclosed, which in some embodiments, can include memory coupled to at least one processor, the at least one processor configured to: receive a user request for a service facilitated by a telecommunications network, the user request identifying a location of a user; identify, based on the service, a device or port to which the user connects to access the telecommunications network; send, based on the device or port, discovery commands to retrieve information from one or more additional devices in the telecommunications network; retrieve, based on the discovery commands, the information from the one or more additional devices; identify, based on the information, a second device to which the device or port may connect to generate a path to an endpoint of the telecommunications network; generate, based on the device or port and the second device, a path from the location of the user to the endpoint in the telecommunications network; and provision the service for the user based on the path without presenting a quote to the user indicating an amount of time expected to provision the service.

According to some embodiments, a non-transitory computer-readable storage medium including instructions to cause at least one processor for provisioning resources in a telecommunications network is disclosed, which upon execution of the instructions by the at least one processor, causes the at least one processor to: receive a user request for a service facilitated by a telecommunications network, the user request identifying a location of a user; identify, based on the service, a device or port to which the user connects to access the telecommunications network; send, based on the device or port, discovery commands to retrieve information from one or more additional devices in the telecommunications network; retrieve, based on the discovery commands, the information from the one or more additional devices; identify, based on the information, a second device to which the device or port may connect to generate a path to an endpoint of the telecommunications network; generate, based on the device or port and the second device, a path from the location of the user to the endpoint in the telecommunications network; and provision the service for the user based on the path without presenting a quote to the user indicating an amount of time expected to provision the service.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is an example process for activating a service using a telecommunications network path in accordance with some embodiments of the present disclosure;

FIG. 2 is an example process for activating a service using a telecommunications network path in accordance with some embodiments of the present disclosure;

FIG. 3 is a flow for a process for activating a service using a telecommunications network path in accordance with some embodiments of the present disclosure; and

FIG. 4 is a diagram illustrating an example of a computing system that may be used in accordance with some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, as discussed herein, the instant disclosure provides systems, methods, and the like, for activating services and devices in a telecommunications network.

According to some embodiments, when a user of a telecommunications network requests activation of telecommunications network resources, an inventory-based build may occur to develop a path between the user and one or more endpoints, and to activate computer resources along the path to facilitate one or more services. However, the information in the network inventory may not always be in sync with the actual status of resources in the telecommunications network. For example, a network device may be replaced, but the network inventory reflecting that replacement may not be updated/available, so an inventory-based build may rely on outdated and sometimes conflicting information about which computer resources are available. Network collisions and errors that delay the delivery of services to a user may result from such an inventory-based path.

According to some embodiments, a typical user order for a telecommunications network may include the user providing some information, an inventory-based design (e.g., system architecture) of the network path for the user being generated, and a quote estimating the amount of time needed to build the design for the user being provided to the user. When an inventory-based path relies on outdated or conflicting information from the inventory, not only may errors occur when trying to activate and use the path, but also the estimated time for activation provided to the user may not be met. For example, when the generated path fails, a system designer may have to redesign the path, resulting in delays and challenges in updating the inventory to be in sync with the network.

In one or more embodiments, rather than relying on a user order and inventory-based design, network paths may be generated on-demand without having to first update network inventory. In this manner, the path and its telecommunications network resources may be turned up even if the network inventory has not yet been updated. The path computation may occur at provision time without needing to generate the path as an offer. For example, rather than generating an inventory-based design with an estimated build time quote presented to a user as an offer for the user to accept or reject, a system may receive user information for the activation and build the path without having to present it with the quote as an offer to the user.

In one or more embodiments, to build the path while avoiding errors, the system may walk the network to identify available resources rather than relying exclusively on the network inventory for network resource status information. The system may retrieve the network resources before the build. Such a “network as inventory” approach may allow the system to identify available network resources such as virtual local area networks, subinterfaces, route targets, and the like to establish network paths between users and a network core by identifying a next connected device and port rather than relying on network inventory that may not reflect the most updated status information of network resources. For example, rather than using network inventory to identify an available virtual local area network, the system may examine the network to identify a port to provision, identify an available virtual local area network on that port, and assign that port to the service for the user. As a result, generated network connections may be more reliable and available faster to a user. In addition, the network inventory may be updated as a separate process so as to not delay deployment of the path. As a result, the resources of the path may become available immediately to the user rather than waiting until inventory has updated, and the inventory may not need to be updated after a path is built if a user disconnects, for example.

In one or more embodiments, rather than relying on network inventory, the network path from a user's location to an endpoint may be based on the service requested by the user, the amount of bandwidth requested by the user, and potentially other information. When the user provides this information to the system, the system may identify devices and ports near the user's location, identify resources to provision for the service, and continue to identify a next device and port(s) for the service (e.g., based on the availability and capabilities of the resources in comparison to the requested service and bandwidth of the user) until the path is constructed. The system may follow up with a user to inform the user of the status (e.g., success or failure) of the provisioning of the network path regardless of the status of the inventory, so the inventory synchronization and updating may not delay the user's ability to use the network.

In one or more embodiments, a telecommunications network user may provide a request for a service facilitated by the telecommunications network. A provisioning system of the network may receive the request, which may identify the user, the user's location (e.g., device/network location), requested service(s), and requested bandwidth (e.g., if the service is a bandwidth service), for example. The information provided in the request may be based on the requested service. Based on the request, the provisioning system may discover a network path by retrieving network resources from the network. For example, the provisioning system may connect to a device or port of the user's location (e.g., a device or port to which the user has connected to access the telecommunications network), send discovery commands (e.g., using multicast label distribution protocol or the like) to retrieve information from other network devices, and identify the nearby devices based on responses to the discovery commands until a path to the desired destination is generated. Similarly, the provisioning system may retrieve any virtual local area networks configured on the network devices and subinterfaces on ports of the network devices to identify next available devices, virtual local area networks, subinterfaces, route targets, and the like for the network path. The provisioning system may create the service using the network path, and respond to the user with a status update (e.g., success/failure) for the provisioning. At this time, the user may use the provisioned path for a requested service. In this manner, the path is generated and provisioned in real-time rather than as part of an offer (e.g., quote) that the user has to subsequently accept.

In one or more embodiments, the provisioning system may update the network inventory based on the resources used in the network path so that the inventory is in sync with the actual network resource usage. When there are differences between the network resources and the inventory, the provisioning service may reconcile the differences to update the inventory, and in some situations, may update the network path based on information in the inventory. For example, sometimes the network inventory may be correct instead of the as-built network, such as when a previous provisioning act failed, but should exist in the as-built network and is documented in the inventory.

The above descriptions are for purposes of illustration and are not meant to be limiting. Numerous other examples, configurations, processes, etc., may exist, some of which are described in greater detail below. Example embodiments will now be described with reference to the accompanying figures.

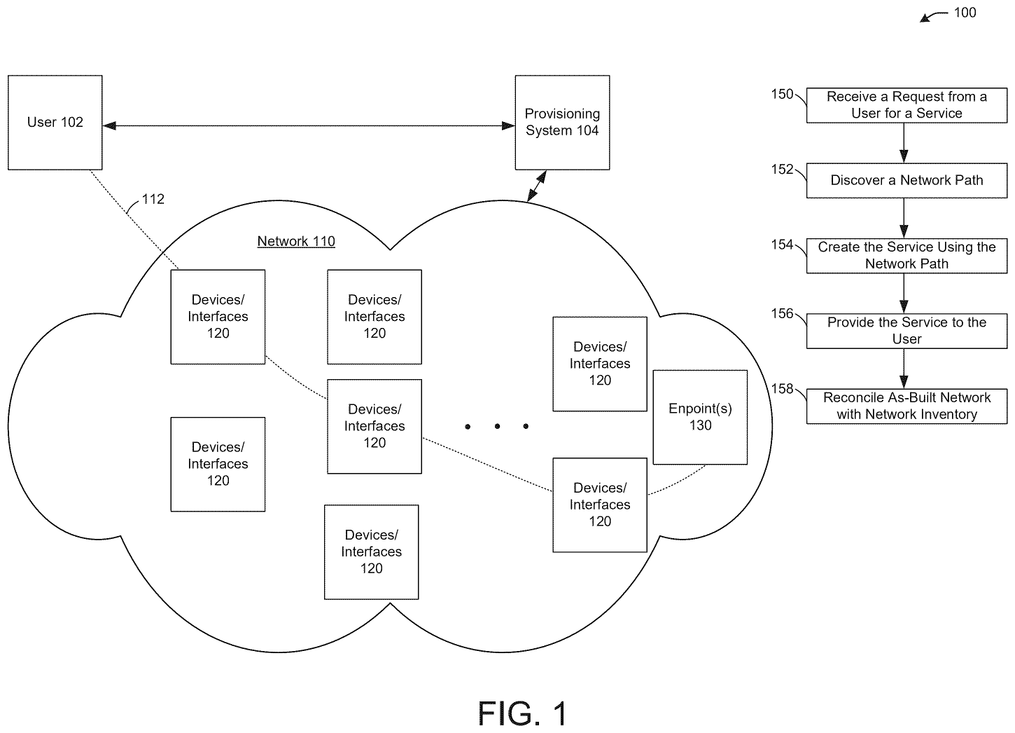

FIG. 1 is an example process 100 for activating a service using a telecommunications network path in accordance with one embodiment.

Referring to FIG. 1, user 102 may request, to a provisioning system of a telecommunications network 110, a service using the telecommunications network 110. The request may identify the service(s) requested by the user 102 and additional information, such as the location of the user 102 (e.g., user's device or a device/port to which the user's device connects to access the network 110). The service may use a network 110 and a path 112 through the network from the API user 102, through one or more devices/interfaces 120 (e.g., resources of the network 110), and to an endpoint 130 for the service (e.g., within a core network).

Still referring to FIG. 1, the provisioning system 104 may receive the request from the user at block 150. In response to the user request for a service, the provisioning system 104 may discover a network path, at block 152, from the user 102 (or device/port to which the user 102 connects to access the network 110) to the one or more endpoints 130 for the requested service. To discover the network path, the provisioning system 104 may send commands to the devices/interfaces 120 in the network 110 requesting information about devices, interfaces/subinterfaces, virtual local area networks, and the like. Using the information received from the network resources in response to the commands, the provisioning system 104 may identify a next available device/port (e.g., nearest to the user's location), and a next nearest available device/port from there, and so on, until the path 112 is generated for the requested service. When the service has certain requirements, such as bandwidth, the next available device/port may be selected based on whether the nearby device/port can support the service and its requirements. At block 154, when the path 112 is built, the provisioning system may create the service using the network path 112 (e.g., provision the network resources of the path 112 to be used with the requested service and by the user 102). At block 156, the provisioning system 104 may respond to the user's request with a confirmation of the path 112 for the service, thereby providing the service to the user via the path 112. At block 158, the provisioning system 104 may update network inventory to reflect the resources used for the path 112 and reconcile any conflicts between the path 112 and the inventory.

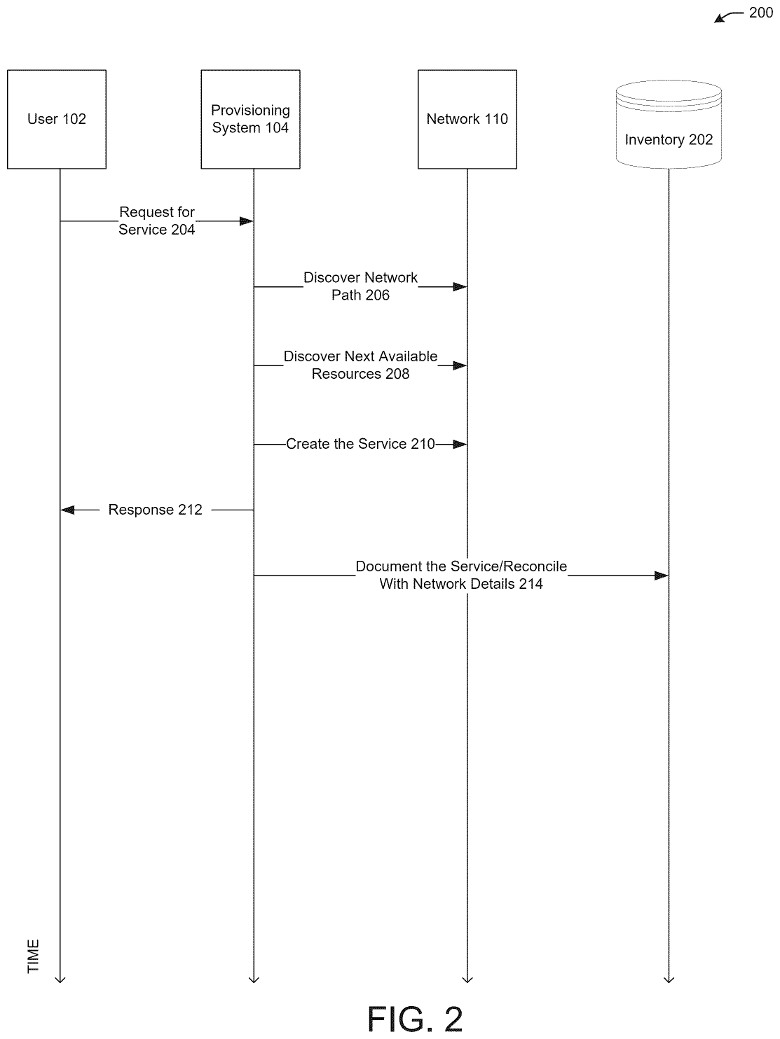

FIG. 2 is an example process 200 for activating a service using a telecommunications network path in accordance with one embodiment.

Referring to FIG. 2, the provisioning system 104 of FIG. 1 may have access to network inventory 202, which may document the use of resources on the network 110. For example, when a network path such as the path 112 is generated, the network inventory 202 may be updated to reflect the use of the devices, ports, subinterfaces, virtual local area networks, and the like used to provide the service using the path 112. The process 200 may include the user 102 requesting 204 a service (e.g., as in block 150). Based on the requested service(s) and other information in the request 204, the provisioning system 104 may discover a network path 206 (e.g., as in block 152, discovering the path 112 of the network 110) and next available network resources 208 without having to use the network inventory 202. In this manner, building the network path may use the network 110 itself as the inventory by requesting information from network resources to identify a next hop in the path 112 to satisfy the user's requested service. The provisioning system 104 may create the service 210 by provisioning the selected network resources for the path 112, and the provisioning system 104 may respond 212 to the user 102 confirming success or failure of the provisioning. Once the path 112 has been created and turned up for the service and the user 102, the provisioning system 104 may document the service and reconcile the network details with the network inventory 202 at step 214.

Referring to FIGS. 1 and 2, rather than relying on a user order that presents the path 112 as an offer, and rather than generating the path 112 as an inventory-based design, the network path 112 may be generated on-demand without having to first verify and update the network inventory 202. In this manner, the network path 112 and its telecommunications network resources may be turned up even if the network inventory 202 has not yet been updated to reflect network resource usage/status. The path 112 discovery 206 may occur at provision time without needing to generate the path 112 as an offer to the user 102. For example, rather than generating an inventory-based design with an estimated build time quote presented to the user 102 as an offer for the user 102 to accept or reject, the provisioning system 104 may receive user information (e.g., in the user's request for service) for the activation and build the path 112 without having to present a generated path with the quote as an offer to the user.

In one or more embodiments, to build the path 112 while avoiding errors, the provisioning system 104 may walk the network 110 to identify available resources rather than relying exclusively on the network inventory 202 for network resource status information. The provisioning system 104 may retrieve the network resources before the build. For example, rather than using network inventory 202 to identify an available virtual local area network, the provisioning system 104 may examine the network 110 to identify a port to provision, identify an available virtual local area network on that port, and assign that port to the service for the user 102. As a result, generated network connections of the path 112 may be more reliable and available faster to the user 102. In addition, the network inventory 202 may be updated as a separate process so as to not delay deployment of the path 112. As a result, the resources of the path 112 may become available immediately to the user 102 rather than waiting until inventory 202 has updated.

In one or more embodiments, rather than relying on the network inventory 202, the network path 112 from a user's location to an endpoint may be based on the service requested by the user 102, the amount of bandwidth requested by the user, and potentially other information. When the user 102 provides this information to the provisioning system 104, the provisioning system 104 may identify devices and ports near the user's location, identify resources to provision for the service, and continue to identify a next device and port(s) for the service (e.g., based on the availability and capabilities of the resources in comparison to the requested service and bandwidth of the user) until the path 112 is constructed. The provisioning system 104 may follow up with the user 102 to inform the user of the status (e.g., success or failure) of the provisioning of the network path 112 regardless of the status of the inventory 202, so the inventory 202 synchronization and updating may not delay the user's ability to use the network 110.

In one or more embodiments, the user 102 may provide a request for a service facilitated by the telecommunications network 110. Based on the request, the provisioning system 104 may discover the network path 112 by retrieving network resources from the network 110. For example, the provisioning system 104 may connect to a device or port of the user's location (e.g., a device or port to which the user has connected to access the telecommunications network), send discovery commands (e.g., using multicast label distribution protocol or the like) to retrieve information from other network devices, and identify the nearby devices based on responses to the discovery commands until the path 112 is generated. Similarly, the provisioning system 104 may retrieve any virtual local area networks configured on the network devices and subinterfaces on ports of the network devices to identify next available devices, virtual local area networks, subinterfaces, route targets, and the like for the network path 112. The provisioning system 104 may create the service using the network path 112, and respond to the user 102 with a status update (e.g., success/failure) for the provisioning. At this time, the user 102 may use the provisioned path 112 for a requested service. In this manner, the path 112 is generated and provisioned in real-time rather than as part of an offer (e.g., quote) that the user 102 has to subsequently accept.

In one or more embodiments, the provisioning system 104 may update the network inventory 202 based on the resources used in the network path 112 so that the inventory 202 is in sync with the actual network resource usage. When there are differences between the network resources and the inventory 202, the provisioning system 104 may reconcile the differences to update the inventory 202, and in some situations, may update the network path 112 based on information in the inventory 202.

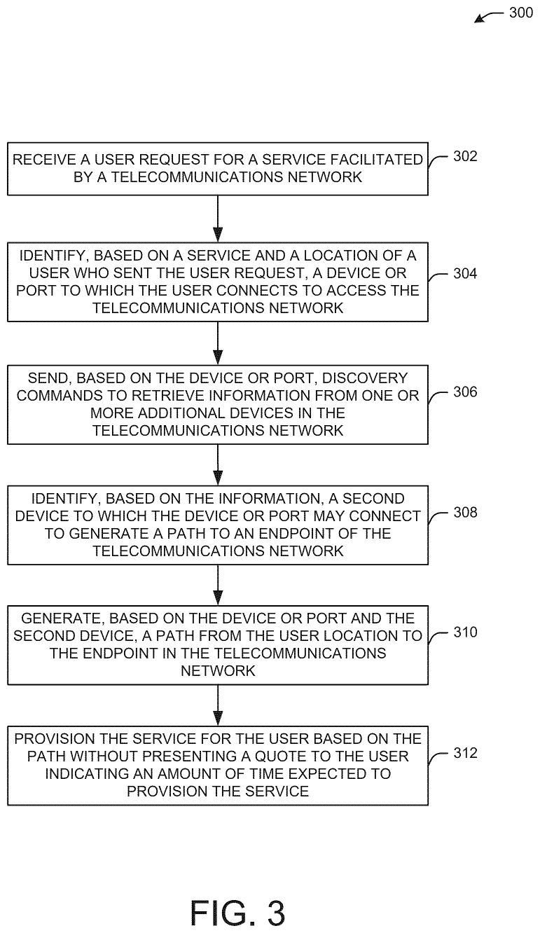

FIG. 3 is a flow for a process 300 for activating a service using a telecommunications network path in accordance with some embodiments.

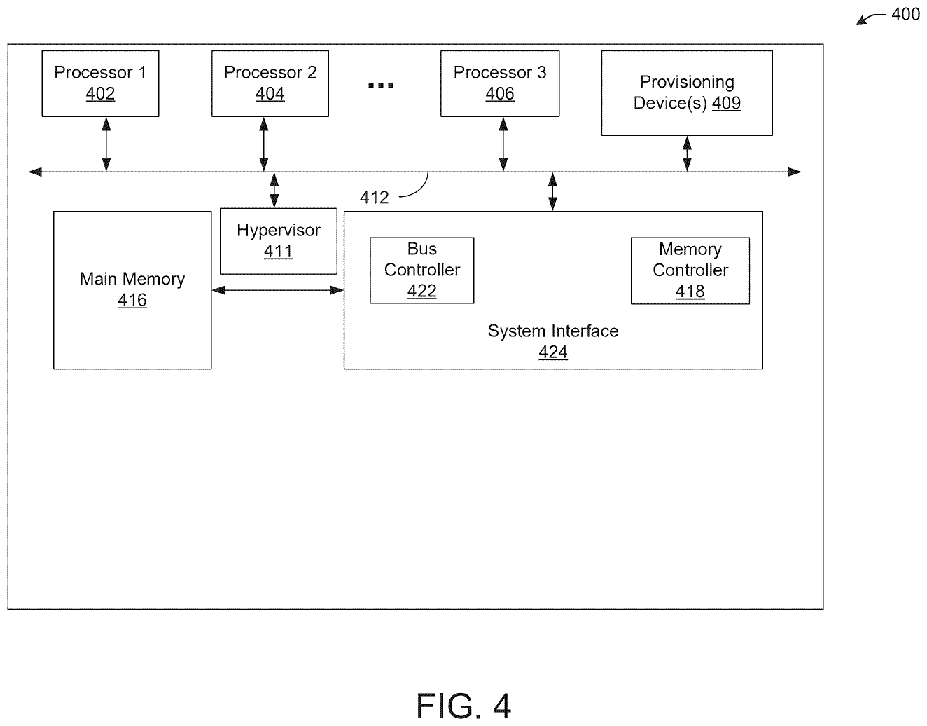

At block 302, the process 300 (e.g., using the provisioning system 104 of FIG. 1, the provisioning devices 409 of FIG. 4) may receive a user request for a service facilitated by the telecommunications network. The service may not be provisioned yet by the telecommunications network for the user. Instead of building an inventory-based estimate to present to the user regarding an estimated amount of time to provision the requested service, the device may provision the service in real-time and allow the user to use the service without presenting an offer or before presenting an offer for using the service.

At block 304, the process 300 may identify, based on the requested service and a location of the user (e.g., identified by the user request), a device or port to which the user connects to access the telecommunications network.

At block 306, the process 300 may send, based on the device or port, discovery commands to retrieve information from one or more additional devices in the telecommunications network. Because the telecommunications network may support different types/brands of devices, ports, etc., the process 300 may need to identify nearby devices and which protocols they use for communication, and use those protocols for the commands.

At block 308, the process 300 may identify, based on the retrieved information, a second device (and other devices) in the telecommunications network to which the device or port (or a subsequent device or port along a path) to an endpoint of the network to form a path for the service.

At block 310, the process 300 may generate, based on the device or port and based on any subsequent devices or ports (e.g., the second device), a path from the user's location to the endpoint in the telecommunications network to facilitate the service for the user.

At block 312, the process 300 may provision the service for the user based on the path without estimating time to provision and presenting the time to provision to the user as an offer for the user to accept in advance. Once the user requests the service and the path is generated in the network, the path and service may be provisioned by configuring and turning up the devices in the path (e.g., using their respective protocols to send commands).

As discussed above, it is understood that the above descriptions are for purposes of illustration and are not meant to be limiting.

FIG. 4 is a block diagram illustrating a non-limiting example of a computing device or computer system 400 which may be used in implementing the embodiments of the components of the network disclosed above. For example, the computing system 400 of FIG. 4 may represent at least a portion of FIG. 1, as discussed above, such as components of the user 102, the provisioning system 104, the devices/interfaces 120, and/or the endpoints 130. The computer system (system) includes one or more processors 402-406, one or more provisioning devices 409 (e.g., representing at least a portion of the provisioning system 104 and including one or more software modules), and a hypervisor 411 (e.g., to instantiate and run virtual machines). Processors 402-406 may include one or more internal levels of cache (not shown) and a bus controller 422 or bus interface unit to direct interaction with the processor bus 412. Processor bus 412, also known as the host bus or the front side bus, may be used to couple the processors 402-406 with the system interface 424. System interface 424 may be connected to the processor bus 412 to interface other components of the system 400 with the processor bus 412. For example, system interface 424 may include a memory controller 418 for interfacing a main memory 416 with the processor bus 412. The main memory 416 typically includes one or more memory cards and a control circuit (not shown). System interface 424 may also include an input/output (I/O) interface 420 to interface one or more I/O bridges 425 or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to the processors 402-406. Another type of user input device includes cursor control, such as a mouse, a trackball, or cursor direction keys for communicating direction information and command selections to the processors 402-406 and for controlling cursor movement on the display device.

System 400 may include a dynamic storage device, referred to as main memory, or a random access memory (RAM) or other computer-readable devices coupled to the processor bus 412 for storing information and instructions to be executed by the processors 402-406. Main memory 416 also may be used for storing temporary variables or other intermediate information during execution of instructions by the processors 402-406. System 400 may include a read only memory (ROM) and/or other static storage device coupled to the processor bus 412 for storing static information and instructions for the processors 402-406. The system outlined in FIG. 4 is but one possible example of a computer system that may employ or be configured in accordance with aspects of the present disclosure.

According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 506 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 416, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations together with all equivalents thereof.

What is claimed is:

1. A method comprising:
receiving a user request for a service facilitated by a telecommunications network, the user request identifying a location of a user;
identifying, based on the service, a device or port to which the user connects to access the telecommunications network;
sending, based on the device or port, discovery commands to retrieve information from one or more additional devices in the telecommunications network;
retrieving, based on the discovery commands, the information from the one or more additional devices;
identifying, based on the information, a second device to which the device or port may connect to generate a path to an endpoint of the telecommunications network;
generating, based on the device or port and the second device, a path from the location of the user to the endpoint in the telecommunications network; and
provisioning the service for the user based on the path without presenting a quote to the user indicating an amount of time expected to provision the service.

2. The method of claim 1, further comprising:
Updating, after the provisioning, inventory for the telecommunications network to indicate that the user is using the path for the service.

3. The method of claim 1, wherein generating the path occurs without information in inventory for the telecommunications network indicating which devices and ports are used for respective users and services.

4. The method of claim 1, further comprising:
identifying at least one of a virtual local area network, a subinterface, or a route target based on the information,
wherein the path uses the at least one of the virtual local area network, the subinterface, or the route target.

5. The method of claim 1, further comprising:
identifying a first command protocol used by the second device; and
identifying a second command protocol used by a third device of the telecommunications network,
wherein the discovery commands comprise a first command using the first command protocol and a second command using a second command protocol.

6. The method of claim 1, further comprising:
sending an indication to the user that the service has been provisioned for the user.

7. The method of claim 1, further comprising:
determining that using the path for the service and the user conflicts with inventory for the telecommunications network; and
updating the inventory to reconcile the conflict.

8. A system comprising:
a memory coupled to at least one processor, the at least one processor configured to:
receive a user request for a service facilitated by a telecommunications network, the user request identifying a location of a user;
identify, based on the service, a device or port to which the user connects to access the telecommunications network;
send, based on the device or port, discovery commands to retrieve information from one or more additional devices in the telecommunications network;
retrieve, based on the discovery commands, the information from the one or more additional devices;
identify, based on the information, a second device to which the device or port may connect to generate a path to an endpoint of the telecommunications network;
generate, based on the device or port and the second device, a path from the location of the user to the endpoint in the telecommunications network; and
provision the service for the user based on the path without presenting a quote to the user indicating an amount of time expected to provision the service.

9. The system of claim 8, wherein the at least one processor is further configured to:
update, after the provisioning, inventory for the telecommunications network to indicate that the user is using the path for the service.

10. The system of claim 8, wherein to generate the path occurs without information in inventory for the telecommunications network indicating which devices and ports are used for respective users and services.

11. The system of claim 8, wherein the at least one processor is further configured to:
identify at least one of a virtual local area network, a subinterface, or a route target based on the information,
wherein the path uses the at least one of the virtual local area network, the subinterface, or the route target.

12. The system of claim 8, wherein the at least one processor is further configured to:
identify a first command protocol used by the second device; and
identify a second command protocol used by a third device of the telecommunications network,
wherein the discovery commands comprise a first command using the first command protocol and a second command using a second command protocol.

13. The system of claim 8, wherein the at least one processor is further configured to:
send an indication to the user that the service has been provisioned for the user.

14. The system of claim 8, wherein the at least one processor is further configured to:
determine that using the path for the service and the user conflicts with inventory for the telecommunications network; and
update the inventory to reconcile the conflict.

15. A non-transitory computer-readable storage medium comprising instructions, that when executed by at least one processor, cause the at least one processor to:
receive a user request for a service facilitated by a telecommunications network, the user request identifying a location of a user;
identify, based on the service, a device or port to which the user connects to access the telecommunications network;
send, based on the device or port, discovery commands to retrieve information from one or more additional devices in the telecommunications network;
retrieve, based on the discovery commands, the information from the one or more additional devices;
identify, based on the information, a second device to which the device or port may connect to generate a path to an endpoint of the telecommunications network;
generate, based on the device or port and the second device, a path from the location of the user to the endpoint in the telecommunications network; and
provision the service for the user based on the path without presenting a quote to the user indicating an amount of time expected to provision the service.

16. The non-transitory computer-readable storage medium of claim 15, wherein execution of the instructions further causes the at least one processor to:
update, after the provisioning, inventory for the telecommunications network to indicate that the user is using the path for the service.

17. The non-transitory computer-readable storage medium of claim 15, wherein to generate the path occurs without information in inventory for the telecommunications network indicating which devices and ports are used for respective users and services.

18. The non-transitory computer-readable storage medium of claim 15, wherein execution of the instructions further causes the at least one processor to:
identify at least one of a virtual local area network, a subinterface, or a route target based on the information,
wherein the path uses the at least one of the virtual local area network, the subinterface, or the route target.

19. The non-transitory computer-readable storage medium of claim 15, wherein execution of the instructions further causes the at least one processor to:
identify a first command protocol used by the second device; and
identify a second command protocol used by a third device of the telecommunications network,
wherein the discovery commands comprise a first command using the first command protocol and a second command using a second command protocol.

20. The non-transitory computer-readable storage medium of claim 15, wherein execution of the instructions further causes the at least one processor to:
determine that using the path for the service and the user conflicts with inventory for the telecommunications network; and
update the inventory to reconcile the conflict.
